(19) United States
(12) Patent Application Publication
(10) Pub. No.: US 2004/0203929 A1
(43) Pub. Date: Oct. 14, 2004

(54) Enhanced caller identification

(76) Inventor: Akhteruzzaman, Naperville, IL (US)

Correspondence Address: Werner Ulrich, 434 Maple Street, Glen Ellyn, IL, 60137, US

(21) Appl. No.: 10/165,239

(22) Filed: Jun. 7, 2002

(51) Int. Cl. H04Q 7/20

(52) U.S. Cl. 455/457; 455/456.1

(57) ABSTRACT

Apparatus and a method for providing location information to the other party of a call between two parties, at least one of which is using a cellular station. The location of the party using the cellular station is determined through the use of a Global Positioning System (GPS) Receiver associated with a cellular station; the identification of the base station and sector being used for communicating with the cellular station; or a location provided by an enhanced 911 location system. The arrangement can also be used for land-based parties.

### TECHNICAL FIELD

This invention relates to arrangements for providing calling or called party information to the called or calling party.

Problem:

Incoming calling line identification is one of the most popular telephone services available today. The called party receives a display indicating the telephone number and/or the name associated with that telephone number of the calling party. The called party is then prepared to respond to the caller or to ignore the caller, and let the call go to a voice mail system, an answering machine, or simply, not to answer the call. While this service answers an important need, Applicant feels that further needs are not being met.

Solution:

Applicant has carefully studied the problem of calling line identification, and has recognized that if the caller is a mobile station, the location of this mobile station is an important piece of data that is not available with calling line identification. Further, Applicant has recognized that in case a call is terminated to a wireless station, the caller is missing an important piece of data; namely, the location of the called party. Accordingly, Applicant has made a contribution over the teachings of the prior art in accordance with his invention, wherein on a call to a wireless station, the calling party is informed of the location of the wireless station, and/or the called party is informed of the location of a calling wireless station.

In accordance with one preferred embodiment of Applicant's invention, the other party is informed of the location of a wireless station by the best method available for locating that station. Today, the best method of locating the station is through the use of the Global Positioning System for any station equipped with a GPS Receiver. Alternatively, if the enhanced “911” (E.911) system is used, a mobile station can be located within a relatively small distance. Failing the availability of either of these facilities, the general location of a mobile station can still be identified by the identity of the cellular station and sector of that station being used to communicate with the party whose location is sought. Advantageously, with this arrangement, the best available information concerning the location of the other party is provided to the requesting party.

In accordance with one preferred embodiment, a party may permanently request location information for all calls to or from a cellular station, or a request on a particular call may be made by dialing a special prefix. Advantageously, the location process is only initiated when revenue can be derived from that process.

In accordance with one preferred embodiment, the location information is provided on either a visual display or via oral information. The information can be, for example, a road intersection and city, or a major landmark, such as a mall, museum, or historic landmark. A database is used to translate between the actual geographic location and the information to be provided to the requesting party.

In accordance with one preferred embodiment of this invention, the location is provided if the called cell phone is powered-on even if the called party does not answer.

In accordance with one feature of this invention, calling or called parties who wish to avoid disclosing their locations can do so by dialing directing digits, or by a class of service.

In accordance with one feature of Applicant's invention, the location of a land-based line can also be provided.

### BRIEF DESCRIPTION OF THE DRAWING(S)

FIG. 1 is a block diagram illustrating the architecture of Applicant's invention; and

FIG. 2 is a flow diagram illustrating the operation of Applicant's invention.

### DETAILED DESCRIPTION

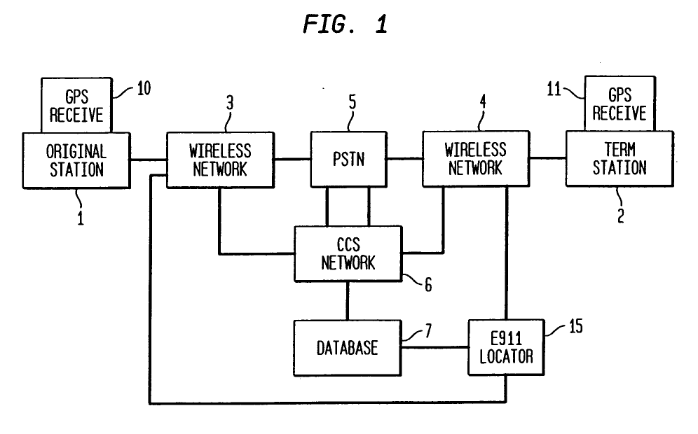

FIG. 1 is a block diagram illustrating the architecture of Applicant's invention. An Originating Station (1) calls a Terminating Station (2). In the diagram, the Originating Station and Terminating Station are both wireless stations connected to the Public Switched Telephone Network (5) by wireless networks (3) and (4), respectively. However, either the Originating Station or the Terminating Station, may be a land-line station so that, for example, if the Originating Station (1) is a land-line station, and wishes to know the location of a call terminated to a cellular station (2), this information can be provided. Even if both stations are land-based, the location information can be provided.

In the example of FIG. 1, the Originating Station (1) is provided with a Global Positioning System (GPS) Receiver (10), and Terminating Station (2) is provided with a GPS Receiver (11). These Receivers will provide very accurate information concerning the present location of these stations. If the station whose location is being requested does not have a GPS Receiver, then the enhanced “911” (E.911) Locator System (15) can be used to find the approximate location of a cellular station. If the E.911 Locator System is not available, or if the Government chooses not to make the E.911 Locator available commercially, then the wireless network can provide approximate location information by providing the identity of the base station and sector which is currently being used to communicate with the station whose location is being requested.

The information from the GPS Receivers or the wireless network is sent via Common Channel Signaling Network (6) to a database (7), which translates between location information provided by one of these sources and the desired information to be displayed or spoken to the requesting party. The output of the E.911 Locator (15) is also fed to the database (7) for a similar translation. The information from the database is then sent back via the CCS7 Network (6) to the requesting station for display or announcement.

For a land-based originating station, the originating party's location can be derived from the calling telephone number via the database (7). This can also be done for a land-based terminating station.

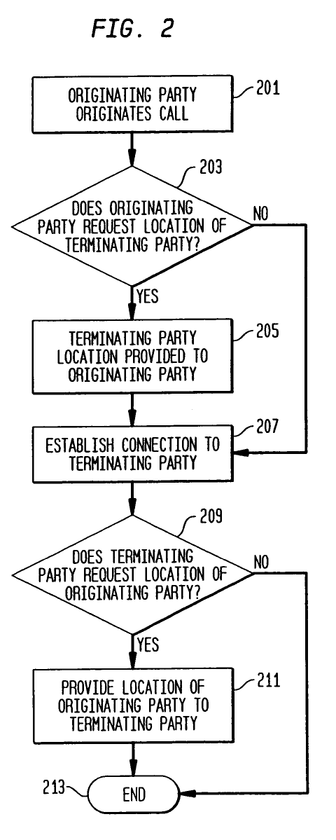

FIG. 2 is a flow diagram illustrating the operation of Applicant's invention. An originating party originates a call, Action Block (201). Test (203) is used to determine whether the originating party requests the location of a terminating party. The originating party can have a class of service which requests the location of a terminating party on all calls to a cellular station, or all calls, including calls to a land-based station. Alternatively, the originating party can dial a special prefix to request such information. If the originating party does so request, then the terminating party location is provided to the originating party, Action Block (205). This location information is provided by database (7) based on information from a GPS Receiver of the terminating party, wireless network information concerning the base station and sector being used for communicating with the terminating party, or on the basis of information provided by the E.911 Locator (15), for a mobile station, or based on the called directory number for a land-based station. Regardless of the outcome of Test (203), an attempt is made to establish a connection to the terminating party, Action Block (207). Test (209) is then used to determine whether the terminating party requests the location of the originating party. The terminating party can have a class of service wherein the location of any calls from a cellular station or a cellular land-based station are requested, or the terminating party can request the location of the originating party based on information dialed by the terminating party, usually, in response to calling line identification information. The called party signals that a request is being dialed by pressing a directing digit, (e.g., *), at the time of going off-hook, the off-hook signal is then deferred until the called party has finished dialing the directing digits. If a terminating party does request this location information, then the location information is provided, Action Block (211) in much the same way as the terminating party location is provided to the originating party as described with respect to Action Block (205). Subsequently, the two parties may talk, although as previously discussed, the location of the originating party can be provided to the terminating party and vice versa, even if the terminating party does not answer the call.

The above is a description of one preferred embodiment of Applicant's invention. Other embodiments will be apparent to those of ordinary skill in the art without departing from the scope of the invention as defined in the attached claims.

I claim:

1. In a call between an originating party and a terminating party at least one of which is using a cellular station, a method of providing information to one of said parties about the other party if that party is using a cellular station, comprising the steps of:
determining whether a station is requesting location information about the connected station if that connected station is a cellular station; and
if a requesting station has requested location information, providing that location information to the requesting station.

2. The method of claim 1, wherein the step of providing the location information comprises the steps of:
determining a geographic location of said station;
translating from said geographic location to a location identifiable by a user; and
displaying, or announcing said location identifiable by a user to said user.

3. The method of claim 2, wherein the step of locating said station comprises the step of:
locating said station using a Global Positioning System (GPS) Receiver associated with said station.

4. The method of claim 3, wherein the step of locating said station, comprises the step of:
providing information concerning which base station and which sector of said base station is being used for communicating with said station.

5. The method of claim 3, wherein the step of locating said station, comprises the step of:
using an enhanced 911 location system to locate said station.

6. The method of claim 1, wherein the step of determining whether said station has requested the location of said station has a class of service wherein the location of all called parties that are using cellular stations is requested.

7. The method of claim 1, wherein the step of determining whether said station has requested the location of said station has a class of service wherein the location of all calling parties that are using cellular stations is requested.

8. The method of claim 1, wherein the step of testing whether said station has requested a location comprises the step of testing whether said station has dialed a requesting code.

9. The method of claim 1, wherein said requesting station is an originating station.

10. The method of claim 1, wherein said requesting station is a terminating station.

11. In a call between an originating party and a terminating party, a method of providing information to one of said parties about the other party, comprising the steps of:
determining whether a station is requesting location information about the connected station; and
if a requesting station has requested location information, providing that location information to the requesting station.
